(19) United States
(12) Patent Application Publication
(10) Pub. No.: US 2026/0270843 A1
(43) Pub. Date: Sep. 10, 2026

(54) NETWORK DEVICES AND CONNECTION SWITCHING METHOD

(71) Applicant: SENAO NETWORKS, INC., Taoyuan (TW)

(72) Inventor: Yu-Cheng CHOU, Taoyuan (TW)

(21) Appl. No.: 19/245,813

(22) Filed: Jun. 23, 2025

(30) Foreign Application Priority Data
Mar. 7, 2025 (TW) 114108579

(51) Int. Cl. H04W 40/24; H04W 40/34; H04W 76/18

(52) U.S. Cl. CPC H04W 40/248; H04W 40/34; H04W 76/18

(57) ABSTRACT

A network device includes a storage, a processor, and a transceiver. The storage is configured to store a path list. The processor is configured to generate a first switching instruction packet according to the path list. The transceiver is configured to transmit the switching instruction packet to a mobile device to instruct the mobile device to switch its connection to a target network device.

### CROSS-REFERENCE TO RELATED APPLICATIONS

This application claims priority to Taiwan Patent Application No. 114108579 filed on Mar. 7, 2025, which is hereby incorporated by reference in its entirety.

### BACKGROUND OF THE INVENTION

The present invention relates to a network device and a connection switching method. More specifically, the present invention relates to a network device and a connection switching method that instruct a mobile device to switch connections through a path list.

In the field of traditional network roaming technology, a network topology is usually formed by a plurality of network devices, such as wireless base stations/access points (APs), in a specific arrangement, in which each network device has a signal range and overlaps with the signal range of at least one other network device. However, when a user's mobile device needs to connect to a target network device, it still needs to search for the signals of surrounding network devices before establishing a connection with target wireless base station even if the mobile device has a record of connecting to the target network device before. In this case, the efficiency of switching connections of the mobile device between different wireless base stations will be poor.

Furthermore, if there are multiple wireless base stations with similar signal strengths around at the same time, a ping-pong effect may occur (i.e., the mobile device cannot determine which wireless base station is appropriate, causing it to repeatedly try to connect among multiple wireless base stations). Therefore, how to enable the mobile device to efficiently obtain a precise connection to a proper target is an urgent technical problem that needs to be solved in the technical field to which this invention belongs.

### SUMMARY OF THE INVENTION

To overcome the aforementioned technical problem, the embodiments of the present invention provide a network device. The network device may include a storage, a processor and a transceiver, and the processor is electrically connected to the storage and the transceiver. The storage is configured to store a path list. The processor is configured to generate a first switching instruction packet according to the path list. The transceiver is configured to transmit the first switching instruction packet to a mobile device to instruct the mobile device to switch connection to a target network device.

In order to solve at least the above technical problems, the embodiments of the present invention also provide a connection switching method, which is executed by a network device and may include the following steps: generating a first switching instruction packet according to a path list; and transmitting the first switching instruction packet to a mobile device to instruct the mobile device to switch to a target network device.

As mentioned above, the network device and the connection switching method disclosed by the present invention can store a path list in advance, generate a switching instruction packet according to the path list, and transmit the first switching instruction packet to the mobile device. In this way, since the target network device which the mobile device will connect with is recommended by the first switching instruction packet, the mobile device can connect to the target network device before its network signal quality deteriorates and such a connection can be established without searching surrounding network devices by the mobile device. In addition, the ping-pong effect can be effectively avoided. Therefore, the present invention can indeed effectively solve the above problems.

The above contents are not intended to limit the present invention, but only briefly describes the technical problems that can be solved by the present invention, the technical means that can be adopted, and the technical effects that can be achieved, so that those with ordinary knowledge in the technical field to which the present invention belongs can have a preliminary understanding of the present invention. Based on the attached drawings and the contents described in the following embodiments, those with ordinary knowledge in the technical field to which the present invention belongs can further understand the details of various embodiments of the present invention.

### BRIEF DESCRIPTION OF DRAWINGS

FIG. 1 is a schematic view illustrating the architecture of a network device and its interaction with a mobile device according to some embodiments of the present invention.

FIG. 2A to FIG. 2B are schematic views illustrating how a network device generates a path list according to some embodiments of the present invention.

FIG. 3 is a schematic view illustrating how a network device generates a first movement path and a second movement path according to some embodiments of the present invention.

FIG. 4 is a schematic view illustrating how a network device generates a second handover indication packet according to some embodiments of the present invention.

FIG. 5 is a flow chart illustrating a connection switching method according to some embodiments of the present invention.

### DETAILED DESCRIPTION OF THE INVENTION

The present invention will be described below through multiple embodiments. These embodiments, however, are not intended to limit the present invention to only be implemented according to specific operations, environments, applications, structures, processes or steps. The attached drawings are only used to facilitate explanations of the following embodiments and are not intended to limit the scope of the present invention. It should be understood that those elements which are not directly related to the present invention have been omitted and will not be shown. Those elements, however, may be implicit in the drawings, and the dimensions of each element and the proportions for each element in the drawings are provided for facilitating illustration and explanation only, and are not used to limit the scope of the present invention. In addition, unless otherwise specified, in the following contents, the same (or similar) element symbols may correspond to the same (or similar) elements, and if possible, the number of each element described below may be one or more.

The terms used in the present invention are only used to describe the embodiments and are not intended to limit the present invention. The singular form “a” and “an” are intended to include the plural form as well, unless the context clearly indicates otherwise. Words such as “comprise” and “include” indicate the presence of stated features, integers, steps, operations, elements and/or components, but do not exclude the presence of one or more other features, integers, steps, operations, elements, components and/or combinations of the foregoing features. The term “and/or” includes any and all combinations of one or more of the associated listed items. In addition, the use of terms such as “first” and “second” to describe the characteristics, integers, steps, operations, elements, components and/or groups stated subsequently is not intended to limit the order of the described objects, but is only used to distinguish these objects.

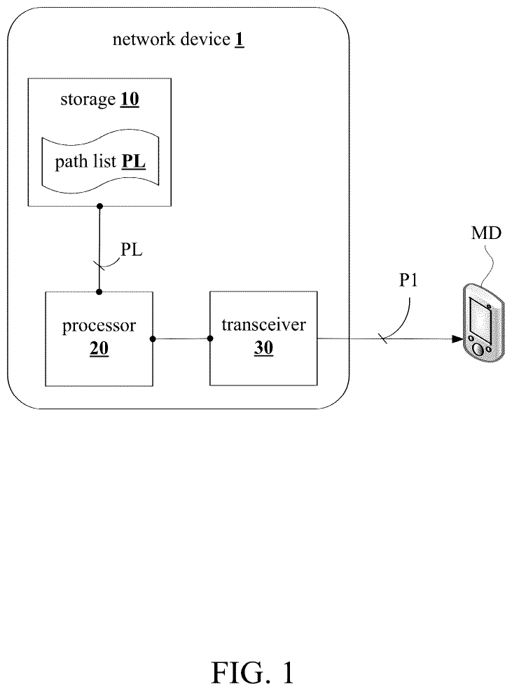

Certain embodiments of the present invention relate to a network device 1. FIG. 1 illustrates a schematic architectural view of a network device 1 according to some embodiments of the present invention. The contents disclosed in FIG. 1 is only for illustrating certain embodiments of the present invention, but is not intended to limit the scope of the present invention.

As shown in FIG. 1, the network device 1 basically includes a storage 10, a processor 20 and a transceiver 30, wherein the processor 20, the storage 10 and the transceiver 30 are electrically connected (directly or indirectly) to each other. The network device 1 may be, but not limited to, wireless transceiver equipment such as a station (STA), a laptop computer, a mobile device, a tablet computer, and/or an access point (AP), a router, switch, computer equipment, server equipment, a workstation and other fixed wireless transceiver equipment, and other devices that can perform network connection with a mobile device MD. In addition, the network device 1 has a signal range that can overlap with the signal range of at least one other network device. When the mobile device MD is within the signal range of the network device 1, it means that it can connect to the network device 1.

Depending on the requirements, the storage 10 may include a first-level memory (such as main memory or internal memory), a second-level memory (such as a hard disk, an optical disk, also called external memory or auxiliary memory), and/or a third-level memory (such as a pluggable storage device, or a cloud hard drive). The first level memory may store the set of instructions to be executed by the processor 20. The second-level memory can transfer stored data to first-level memory. The third-level memory can copy data to the second-level memory or storage device. In addition, the storage 10 may also be any other non-transitory storage medium or device with similar functions known to those of ordinary skill in the same technical field.

The processor 20 can be a programmable integrated circuit, which has the capabilities of operation, storage, output/input, etc., and can accept and process various coded instructions, thereby performing various logical operations and arithmetic operations, and outputting corresponding operation results. The processor 20 can be programmed to interpret various instructions and execute various tasks or programs to complete various actions described in this disclosure. For example, the processor 20 may include: a central processing unit (CPU), a digital signal processor (DSP), a microprocessor, a microcontroller, and/or any other computing device with similar functions known to those of ordinary skill in the technical field to which the present invention belongs.

The storage 10 is configured to store a path list PL, and the processor 20 is configured to generate a first switching instruction packet P1 according to the path list PL (i.e., an instruction used to suggest that the mobile device MD switch the connection target to the next network device). Then, the transceiver 30 is configured to transmit the first switching instruction packet P1 to the mobile device MD to instruct the mobile device MD to connect to the next network device. It should be noted that the next network device to which the mobile device MD is connected is referred to as the “target network device” below.

Specifically, when the mobile device MD gradually moves away from the signal range of the network device 1, a signal strength between the mobile device MD and the network device 1 will begin to decrease. When the signal strength is lower than a preset value, the network device 1 can transmit the first switching instruction packet P1 to the mobile device MD. In addition, when receiving the first switching instruction packet P1, the mobile device MD can determine which one should be the next for connection, that is, the target network device, based on the suggestion of the first switching instruction packet P1.

The path list PL can be stored in the storage 10 in advance and may include information about the target network device specified by the network device 1 for the mobile device MD.

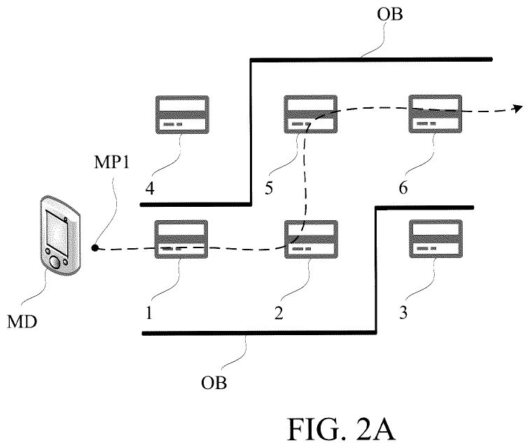

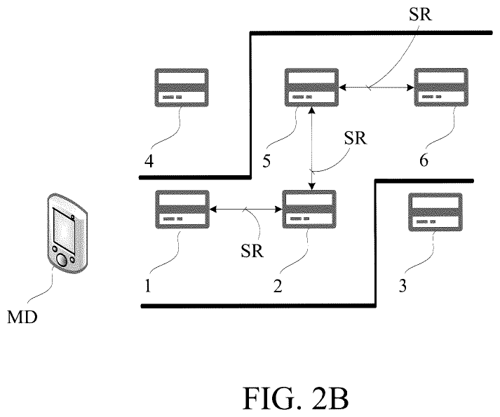

FIGS. 2A and 2B illustrate schematic views disclosing how a network device generates a path list according to certain embodiments of the present invention. The contents shown in FIGS. 2A and 2B are only provided to illustrate embodiments of the present invention and should not be interpreted as any limitation on the claimed invention.

As shown in FIG. 2A, an environment comprises six network devices (network devices 1, 2, 3, 4, 5 and 6), some of which (for example, network devices 3 and 4) are arranged outside obstacles OB (for example, a wall or a steel door). That is to say, for one or more mobile devices MD moving in the environment, since the network signal quality of the network device 3 and the network device 4 is relatively poor, the one or more mobile devices MD typically avoid connecting to the network device 3 and the network device 4. In other words, in such an environment, the conventional mobile device MD typically connects in sequence to the network device 1, the network device 2, the network device 5, and the network device 6. More specifically, as shown in FIG. 2A, when the mobile device MD gradually moves away from the signal range of the network device 1, the network device 1 can generate a first switching instruction packet P1 according to the path list PL to recommend that the mobile device MD connect to the network device 2. Similarly, when the mobile device MID gradually moves away from the signal range of the network device 2, the network device 2 will also generate a first switching instruction packet P1 according to the path list PL to suggest that the mobile device MD connect to the network device 5. In similar manner, when the mobile device MD gradually moves away from the signal range of the network device 5, the network device 5 will also generate a first switching instruction packet P1 according to the path list PL, to suggest that the mobile device MD connect to the network device 6.

In addition, the network device 1 to network device 6 will share their own switching records SR (i.e., the record of switching the connection of the mobile device MID from the source network device to the target network device) with each other, and each of the network device 1 to the network device 6 will create and store a path list PL based on its own switching record SR and the switching records SR of other network devices, and the path list PL will record an optimal movement path with good network signal quality in the environment (including information about each source network device and its corresponding optimal target network device). In other words, in this environment, when the mobile device MD tries to establish a connection with a network device for the first time, the mobile device MD preferentially connects to the network device with optimal network signal quality. In the environment illustrated in FIG. 2A, when the mobile device MD switches the connection from the network device 1 to the network device 2, the network device 1 is the source network device, and the network device 2 is the target network device. When the mobile device MD switches the connection from the network device 2 to the network device 5, the network device 2 becomes the source network device and the network device 5 is the target network device. Since the path list PL stored in each network device includes the switching records SR (i.e., the movement path) indicating an optimal target network devices for each source network device, the first switching instruction packet P1 generated by each network device based on the path list PL can reliably recommend that the mobile device MD connect to an optimal target network device.

By pre-establishing the optimal movement paths (i.e., the path list PL) from the network device 1 to the network device 6, the mobile device MD can switch its connection in a timely manner based on the optimal movement paths when entering the environment. Under the circumstances, the mobile device MD entering the environment avoids connecting to the network device 3 and the network device 4, which are excluded from the optimal movement path. And when the network signal becomes poor, the mobile device MD is not required to search for nearby network devices. In addition, by pre-storing such an optimal movement path (i.e., storing the path list PL) in each of the network device 1 to the network device 6, the mobile device MD can also avoid switching between network devices with unstable signals, thereby preventing a ping-pong effect.

In some embodiments, taking the network device 2 as an example, the transceiver 30 of the network device 2 can be configured to receive a plurality of switching records SR sent by a plurality of adjacent network devices, and the processor 20 of the network device 2 can also be configured to generate the path list PL based on the switching records SR. For example, as shown in FIGS. 2A and 2B, when the connection target of the mobile device MD switches from network device 1 to network device 2, the transceiver 30 of the network device 2 will receive the switching record SR of the source network device 1 (i.e., the switching record SR of the source network device). Accordingly, the processor 20 of the target network device 2 will generate a path list PL based on the switching record SR of the source network device 1 and store it in the storage 10. In other words, the path list PL of the network device 2 contains the switching record SR of the network device 1 and the switching record SR of the network device 5.

It should be noted that the target network device is different from a network device previously connected to the mobile device MD. Specifically, in the above embodiment, the path list PL of the network device 2 contains the switching record SR of the network device 1 and the network device 5, and when the connection target of the mobile device MD switches from the network device 1, which was previously connected to the mobile device MD, to the network device 2, the processor 20 of the network device 2 will exclude the network device 1 from the path list PL. That is to say, the first switching instruction packet P1 generated by the network device 2 will not include various information of the network device 1 previously connected to the mobile device MD, the various information of the network device 1 may include but not limited to service set identifier information, security setting information, wireless channel information, etc. In other words, the first switching instruction packet P1, generated by the network device 2, does not suggest that the mobile device MD connect to the network device 1, but rather to the network device 5. This can effectively prevent the mobile device MD from reconnecting to the network device 1, which was previously connected to the mobile device MD (that is, the so-called “ping-pong effect”).

Furthermore, in FIGS. 2A and 2B, the network device 3 and the network device 4 are blocked by the obstacles OB, resulting in poor network signal quality and making it difficult for mobile device MD to connect to network device 3 and network device 4. Since the mobile device MD cannot easily connect to the network device 3 and the network device 4 while moving through the environment, the network devices 1, 2, 5 and 6 will not receive the switching records SR sent by the network device 3 and the network device 4. In other words, the path lists PL in the storage 10 of the network devices 1, 2, 5 and 6 may not include the switching records SR of the network device 3 and the network device 4. In this way, when the mobile device MID needs to establish connections according to the first switching instruction packet P1 sent by these network devices 1, 2, 5 and 6, it can correctly connect to the target network devices 1, 2, 5 and 6 arranged along the movement path and avoid connecting to the network device 3 and the network device 4, which have poor network signal.

Regarding the following embodiments, since the transceiver 30 of each network device receives the switching records SR from other network devices in the same manner as disclosed in the previous embodiments, the details will not be described again.

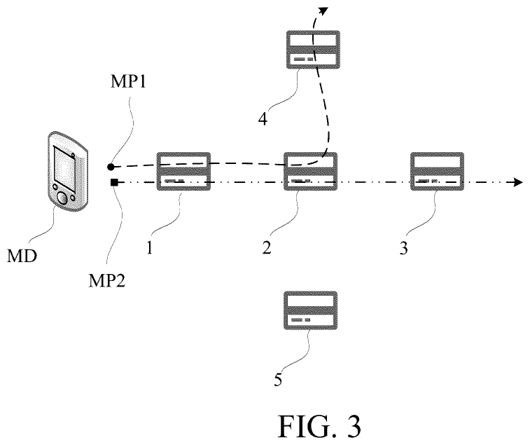

In certain embodiments, the switching records SR in the path list PL may have a priority order. Specifically, it is assumed that there are multiple network devices (such as the network devices 1, 2, 3, 4 and 5 shown in FIG. 3) in an environment, and these network devices are all located in adjacent locations. When the mobile device MD moves within the environment, the mobile device MD may try to connect to these different network devices. Therefore, the path list PL generated by each of the network devices 1, 2, 3, 4 and 5 may correspond to multiple switching records SR. Each switching record SR in the path list PL represents a record of switching the connection of the mobile device MD from a source network device to a target network device, and these switching records SR may be counted statistically to determine the priorities of different movement paths. The switching records SR with the highest statistical counts (e.g., a movement path corresponding to the network devices that the mobile device MD connects to most frequently) in the path list PL will be regarded as the first movement path MP1.

For example, as shown in FIG. 3, if the switching records SR show that the mobile device MD moved from the network device 1 to the network device 2 and then to the network device 4 most frequently, this movement path formed by the switching records SR with the highest statistical counts is regarded as the first movement path MP1 (the first priority). If the switching records SR show that the mobile device MD moved from the network device 1 to the network device 2 and then to the network device 3 second most frequently, this movement path formed by the switching records SR with the second highest statistical counts is regarded as the second movement path MP2 (the second priority). In other words, since the switching records SR forming the first movement path MP1 are more than the switching records SR forming the second movement path MIP2, the processor 20 of each network device will generate the path list PL based on the switching records SR forming the first movement path MIP1 and accordingly generate the first switching instruction packet P1.

It should be noted that since the processor 20 of each network device continuously counts the number of switching record SR, if the number of the switching records SR forming the second movement path MP2 exceeds the number of the switching records SR forming the first movement path MP1, the processor 20 may reassign the original second movement path MP2 as the new first movement path MP1, and reassign the original first movement path MP1 as the new second movement path MIP2. In other words, the priorities of the two movement paths will be exchanged. In this way, in an environment with multiple network devices, an optimal connection sequence for each of the network devices (i.e., the network devices forming the first movement path MIP1) can be provided, enabling the mobile device MD to establish connections efficiently. In addition, the number of the network devices as shown for the first movement path MP1 and the second movement path MP2 is not limited.

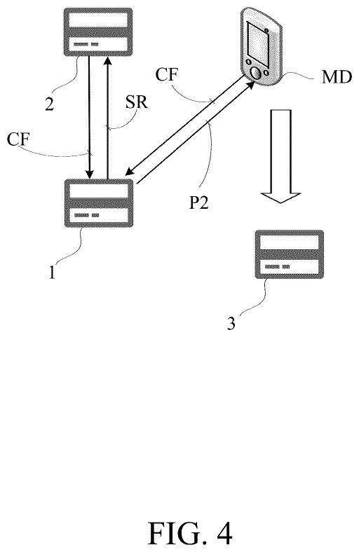

In certain embodiments, as shown in FIG. 4, the transceiver 30 of the network device 1 is also able to configured to receive a connection failure report CF from the target network device 2 or the mobile device MD, and the processor 20 of the network device 1 is also able to configured to generate a second switching instruction packet P2 according to the path list PL in response to the connection failure report CF. Further, the transceiver 30 of the network device 1 is also configured to transmit the second switching instruction packet P2 to the mobile device MID to instruct the mobile device MD to connect to an alternative network device 3.

Specifically, as mentioned above, when the mobile device MD tries to connect to the target network device 2 based on the first switching instruction packet P1 sent by the transceiver 30 of the network device 1, but fails to establish the connection, a connection failure report CF will be generated. Since the network device 1 first sends the switching record SR to the target network device 2, if the target network device 2 does not receive the connection message of the mobile device MD, the processor 20 of the target network device 2 will generate a connection failure report CF and send the connection failure report CF to the network device 1 through the transceiver 30 of the target network device 2. In addition, the mobile device MD can also send the connection failure report CF to the network device 1. Then, the processor 20 of the network device 1 can generate the second switching instruction packet P2 according to the path list PL and send the second switching instruction packet P2 to the mobile device MID through the transceiver 30 of the network device 1. Thereby, the mobile device MD can connect with the alternative network device 3 on the second movement path MP2.

In some embodiments, as shown in FIG. 3, each of the switching records SR of the network devices 1, 2, 3, 4 and 5 includes the information of switching time, switching date, and switching path. Thereby, the processors 20 of the network devices 1, 2, 3, 4 and 5 can determine different optimal movement paths based on such information. For example, if the movement path that is more commonly used by users during normal hours is the first movement path MIP1, and the movement path that is more commonly used by users during holidays is the second movement path MP2, the processor 20 of the network devices 1, 2, 3 and 4 can store the information of the switching time, switching date and switching path from the switching records SR into the path list PL of the storage 10. Then, the processor 20 may send the first switching instruction packet P1 or the second switching instruction packet P2 through the transceiver 30 according to different times and dates.

In some embodiments, the first switching instruction packet P1 includes Service Set Identifier (SSID) information, security setting information, and wireless channel information of the target network device, and the second switching instruction packet P2 includes SSID information, security setting information, and wireless channel information of the alternative network device. For example, the service set identifier is the identification name of the network device 1, and the service set identifier information may include a basic service set identifier (BSSID) and an extended service set identifier (ESSID). In addition, the wireless network security setting may include the security type and network security key of the network device 1, while the wireless channel information may include the channel number and wireless frequency setting used by the network device 1.

In certain embodiments, each network device can exchange Basic Service Set (BSS) information with other network devices through a wired network or a wireless network. Moreover, each network device can detect network signals of surrounding network devices to establish a neighbor network device list. Then, each network device can send switching records SR to network devices listed in the neighbor network device list. After the network devices receive the switching records SR, the processor 20 of each network device can respectively generate a path list PL. In other words, each network device can generate a path list PL according to the neighbor network device list.

In some embodiments, when the signal strength of the mobile device MD is lower than a preset value, the processor 20 of the currently connected network device will generate the first switching instruction packet P1. For example, when the mobile device MD is connected to the network device 1, the processor 20 of the network device 1 can determine the signal strength of the current connection based on the packets sent by the mobile device MD. The processor 20 of the network device 1 is set with a preset value of signal strength, and when the signal strength of the connection between the network device 1 and the mobile device MD is lower than the preset value, the processor 20 of the network device 1 generates the first switching instruction packet P1. In this way, the network device 1 can allow the mobile device MD to switch at an appropriate time point, rather than waiting until the connection signal becomes too weak to maintain the connection, which would otherwise cause the mobile device MD to scan for other network devices on its own.

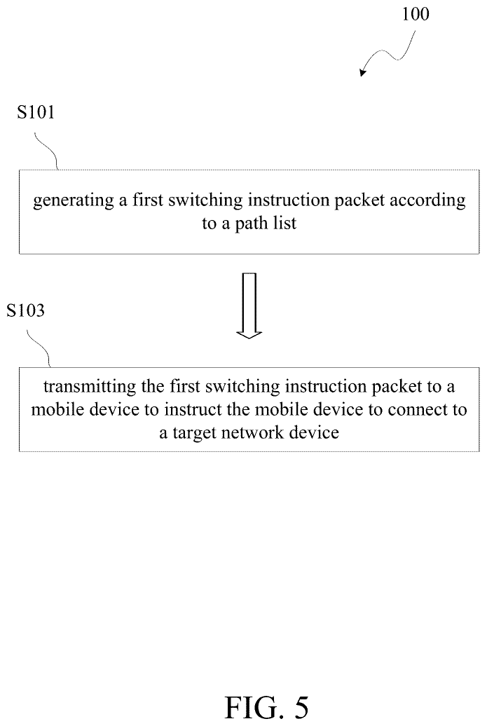

FIG. 5 illustrates a flow chart of a connection switching method for a network device (hereinafter referred to as the “connection switching method 100”) according to some embodiments of the present invention. The content shown in FIG. 5 is only for illustrating the embodiment of the present invention, but is not intended to limit the scope of the present invention.

Referring to FIG. 5, the connection switching method 100 can be executed by a network device and includes the following steps: generating a first switching instruction packet according to a path list (step S101); and transmitting the first switching instruction packet to a mobile device to instruct the mobile device to connect to a target network device (step S103).

In some embodiments of the connection switching method 100, the network device further includes: receiving a plurality of switching records from a plurality of adjacent network devices respectively; and generating the path list based on the plurality of switching records.

In some embodiments of the connection switching method 100, each of the plurality of switching records includes information of switching time, switching date, and switching path.

In some embodiments of the connection switching method 100, the switching records in the path list have a priority order.

In some embodiments of the connection switching method 100, it also includes: receiving a connection failure report from the target network device or the mobile device; generating a second switching instruction packet according to the path list in response to the connection failure report; and transmitting the second switching instruction packet to the mobile device to instruct the mobile device to connect to an alternative network device.

In some embodiments of the connection switching method 100, the first switching instruction packet includes service set identifier information, security setting information and wireless channel information of the target network device, and the second switching instruction packet includes service set identifier information, security setting information and wireless channel information of the replacement network device.

In some embodiments of the connection switching method 100, the target network device is different from a network device previously connected to the mobile device.

In some embodiments of the connection switching method 100, the connection switching method 100 may further comprise: generating the first switching instruction packet when a signal strength of the mobile device is lower than a preset value.

Each embodiment of the connection switching method 100 basically corresponds to a certain embodiment of the network device 1. Therefore, based only on the above descriptions of the network device 1, a person with ordinary skill in the technical field of the present invention can fully understand and implement all the corresponding embodiments of the connection switching method 100, even if all corresponding embodiments of the connection switching method 100 are not described in detail above.

The above embodiments are only examples to illustrate the present invention, and are not intended to limit the scope of the present invention. Any other embodiments resulting from modification, change, adjustment, and integration of the above embodiments, as long as they are easily conceivable by a person with ordinary knowledge in the technical field to which the present invention belongs, are covered by the scope of the present invention. The protection scope of the present invention shall be defined by the following claims.

1. A network device, comprising:
a storage, configured to store a path list;
a processor, electrically connected to the storage and configured to generate a first switching instruction packet according to the path list; and
a transceiver, electrically connected to the processor and configured to transmit the first switching instruction packet to a mobile device to instruct the mobile device to connect to a target network device.

2. The network device according to claim 1, wherein the transceiver is further configured to receive a plurality of switching records from a plurality of adjacent network devices respectively, and the processor is further configured to generate the path list based on the plurality of switching records.

3. The network device according to claim 2, wherein each of the plurality of switching records includes information of switching time, switching date, and switching path.

4. The network device according to claim 2, wherein the plurality of switching records in the path list have a priority order.

5. The network device according to claim 1, wherein:
the transceiver is further configured to receive a connection failure report from the target network device or the mobile device;
the processor is further configured to generate a second switching instruction packet according to the path list in response to the connection failure report; and
the transceiver is further used to transmit the second switching instruction packet to the mobile device to instruct the mobile device to connect to an alternative network device.

6. The network device according to claim 5, wherein the first switching instruction packet includes service set identifier information, security setting information and wireless channel information of the target network device, and the second switching instruction packet includes service set identifier information, security setting information and wireless channel information of the alternative network device.

7. The network device according to claim 1, wherein the target network device is different from a network device previously connected to the mobile device.

8. The network device according to claim 1, wherein when a signal strength of the mobile device is lower than a preset value, the processor generates the first switching instruction packet.

9. A connection switching method executed by a network device, comprising:
generating a first switching instruction packet according to a path list; and
transmitting the first switching instruction packet to a mobile device to instruct the mobile device to connect to a target network device.

10. The connection switching method according to claim 9, further comprising:
receiving a plurality of switching records from a plurality of adjacent network devices respectively; and
generating the path list based on the plurality of switching records.

11. The connection switching method according to claim 10, wherein each of the plurality of switching records includes information of switching time, switching date, and switching path.

12. The connection switching method according to claim 10, wherein the plurality of switching records in the path list have a priority order.

13. The connection switching method according to claim 9, further comprising:
receiving a connection failure report from the target network device or the mobile device;
generating a second switching instruction packet according to the path list in response to the connection failure report; and
transmitting the second switching instruction packet to the mobile device to instruct the mobile device to connect to an alternative network device.

14. The connection switching method according to claim 13, wherein the first switching instruction packet includes service set identifier information, security setting information and wireless channel information of the target network device, and the second switching instruction packet includes service set identifier information, security setting information and wireless channel information of the alternative network device.

15. The connection switching method according to claim 9, wherein the target network device is different from a network device previously connected to the mobile device.

16. The connection switching method according to claim 9, further comprising:
generating the first switching instruction packet when the signal strength of the mobile device is lower than a preset value.
